(19) United States
(12) Patent Application Publication
(10) Pub. No.: US 2012/0052588 A1
(43) Pub. Date: Mar. 1, 2012

(54) MEANS AND METHOD FOR THE DETERMINATION OF THE ALDEHYDE CONTENT

(75) Inventors: Daniel Rupprecht, Heidelberg (DE); Stefanie Beil-Seidler, Moerfelden-Walldorf (DE); Berthold Wagner, Fuchstanzstrasse (DE)

(73) Assignee: MERCK PATENT GESELLSCHAFT MIT BESCHRANKTER HAFTUNG, Dermstadt (DE)

(21) Appl. No.: 13/318,954

(22) PCT Filed: Apr. 19, 2010
(86) PCT No.: PCT/EP10/02373

§ 371 Date: Nov. 4, 2011

(30) Foreign Application Priority Data
May 5, 2009 (DE) 10 2009 019 902.0

(51) Int. Cl. G01N 21/78

(52) U.S. Cl. 436/128

(57) ABSTRACT

The invention relates to a means in the form of a test strip and a method for the rapid determination of the content of aldehydes in samples. The determination is based on the reaction of the aldehydes with phloroglucine

The invention relates to a means in the form of a test stick and a method for the rapid determination of the content of aldehydes.

Aldehydes are important intermediates in organic chemistry for the preparation of plastics and serve as disinfectants and preservatives. The longer-chain aldehydes are used as aromas in the perfume industry.

Owing to their reducing action, aldehydes are employed in particular in the area of disinfection, nowadays predominantly in instrument and surface disinfection. In instrument disinfection, for example, they are the only active compound besides peracetic acids to meet the requirement of the Robert Koch Institute (RKI) for virucidal activity if sterilisation is not subsequently carried out during preparation.

In the past, it was mainly the readily water-soluble, gaseous substance formaldehyde that was of major importance since it has excellent efficacy, including against non-enveloped viruses. Besides disinfection, areas of application that may be mentioned are, in particular, the preservation of a very wide variety of preparations (for example tissue sections) and products (for example cosmetics). However, since formaldehyde is nowadays classified as “carcinogenic to humans”, its use in these areas is decreasing.

Other aldehydes still play an important role in preservation and disinfection, in particular in cold sterilisation. At present, glutaraldehyde and orthophthalaldehyde, in particular, are finding widespread use.

Various methods are known for the determination of aldehydes. An example is the chromotropic acid reaction. Use is frequently also made of amino acids, which either supply a corresponding colour signal directly (Witonsky, R. J.; Larsson, R. P.; U.S. Pat. No. 4,643,980) or which indicate the change in pH as a colour change through the change in pH after reaction of the amino function to give the Schiff's base after addition of a pH indicator (Wu, W. H.; U.S. Pat. No. 6,436,716).

In the area of clinical chemistry, glutaraldehyde is detected using a lateral flow test with phenol as indicator (Smith, J.; WO 00/62060).

Yang, S.-D.; Zhou, T.-H.; Chinese Chemical Reagents 1983; pp. 237-239, describe the detection of aromatic aldehydes using phloroglucine as aldehyde indicator and addition of a strong acid.

In many applications, a rapid, quantitative indication of the concentration of aldehyde is necessary. In particular in the area of disinfectants, it is necessary to be able to check rapidly whether they have a certain minimum content of aldehyde. Only then is the disinfecting action of the agents guaranteed. The proportion of aldehydes in disinfectants is typically a few percent by weight.

The object of the present invention is therefore to provide a simple and rapid method for the determination of the aldehyde content in solutions, for example disinfectants. The method should be rapid to carry out, inexpensive and easy to store in the form of a ready-to-use test kit. In particular, the method according to the invention should enable not only semi-quantitative, visual evaluation, but also quantitative evaluation, for example using a reflectometer.

It has been found that aromatic and non-aromatic aldehydes can be determined simply and quickly using phloroglucine as determination reagent. In contrast to the known method for the determination of aromatic aldehydes using phloroglucine in acidic solution, the determination according to the invention is carried out with the aid of a test stick to which phloroglucine has been applied in basic medium. It has furthermore been found that the addition of a certain amount of one or more primary or secondary amines enables the measurement range to be set accurately. In this way, the quantitative determination of aldehydes becomes possible over a broad concentration range.

The present invention therefore relates to a test stick which has at least one zone which comprises at least phloroglucine and a base.

In a preferred embodiment, the zone of the test stick additionally comprises at least one primary or secondary amine besides phloroglucine and a base.

In a preferred embodiment, the base is sodium hydroxide.

In a preferred embodiment, the primary amine is tris(hydroxymethyl)aminomethane.

In a preferred embodiment, the test stick is produced by impregnating the zone with an impregnation solution which comprises phloroglucine in a concentration of between 0.5 and 500 g/l and has a ph of at least pH 10.

In an embodiment, the test stick has at least two zones which comprise phloroglucine and a base as well as various amounts of a primary or secondary amine.

In a particularly preferred embodiment, the test stick is produced by impregnating the zone or zones with an impregnation solution which comprises phloroglucine in a concentration of between 0.5 and 500 g/l and NaOH in a concentration of between 0.5 and 5 mol/l.

The present invention also relates to a test stick which has at least one zone which comprises at least phloroglucine and a base, which can be produced by
a) provision of a support or test stick at least consisting of a stable substrate and a sorptive support
b) impregnation of the sorptive support with a solution comprising at least phloroglucine and a base
c) application of the sorptive support to a substrate if the sorptive support has not yet been applied to a substrate.

The present invention also relates to a method for the determination of aldehydes, characterised by at least the following method steps:
a) provision of a test stick according to the invention
b) dipping of the test stick into the sample solution
c) visual and/or spectroscopic, preferably reflectometric, evaluation of the coloration of the test strip

In a preferred embodiment, the evaluation in step c) is carried out reflectometrically on the basis of a calibration curve recorded in advance.

The present invention also relates to the use of the test stick according to the invention for the determination of aldehydes in aqueous solutions, such as, in particular, disinfectants.

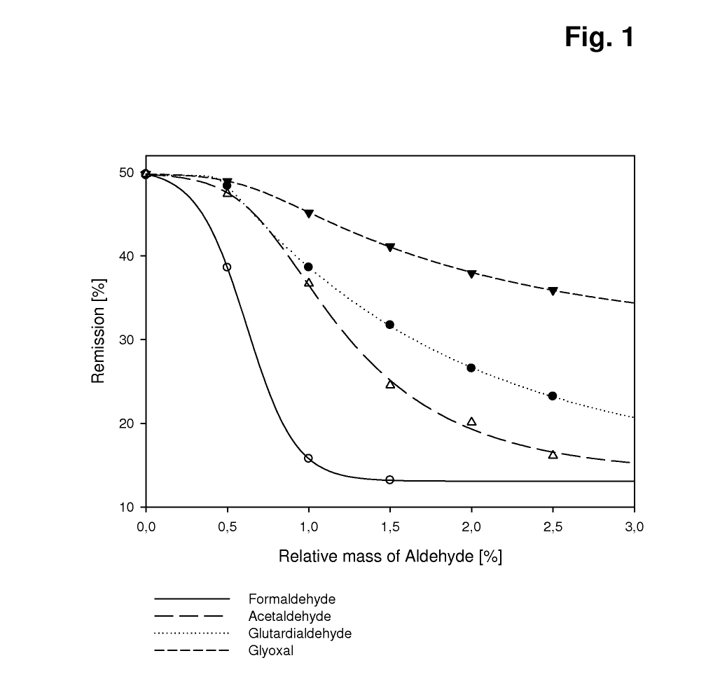

FIG. 1 shows the evaluation of a quantitative reflectometric determination of formaldehyde, acetaldehyde, glutaraldehyde and glyoxal in aqueous solution. Further details are given in Example 2.

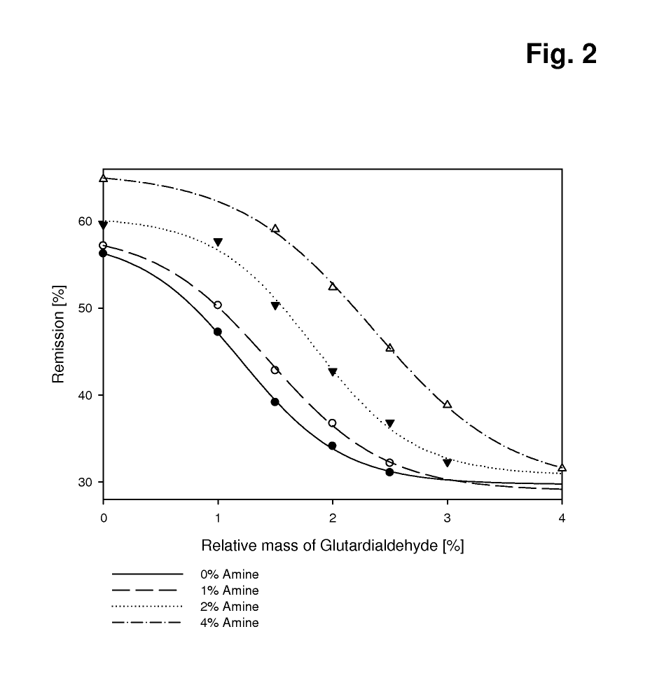

FIG. 2 shows the evaluation of a quantitative reflectometric determination of glutaraldehyde with adjustment of the sensitivity by addition of tris(hydroxymethyl)aminomethane. Further details are given in Example 3.

Aldehydes are chemical compounds which contain an aldehyde group as functional group. The terms aldehyde and aldehyde group are known to the person skilled in the art. Examples of aldehydes which can be determined using the means and method according to the invention are formaldehyde, acetaldehyde, glutaraldehyde, ortho-phthalaldehyde, glyoxal (ethane-1,2-dial) and succinaldehyde (butanedial), preferably glutaraldehyde.

Primary or secondary amines are known to the person skilled in the art. Amines which are suitable in accordance with the invention are, for example, histidine, arginine or ethanolamine. The amine employed in accordance with the invention is particularly preferably tris(hydroxymethyl)aminomethane.

In accordance with the invention, a sample solution is any solution in which aldehydes are suspected or whose aldehyde content is to be determined. They are typically predominantly aqueous solutions. The method according to the invention is particularly suitable for the determination of the aldehyde content in disinfectants. The disinfectants can be employed diluted in a defined manner with water or preferably directly as sample solution. The means and method according to the invention also enable the determination of the aldehyde content of polymerisation solutions in which conclusions can be drawn on the residual monomer content via the aldehyde content.

Analysis using solid, sorptive supports, so-called test sticks, has recently been increasing in importance. The essential advantages of this dry-chemical method include, in particular, simple handling and straightforward disposal owing to the small amounts of reagents. All or the great majority of the reagents necessary for the determination reaction are embedded in corresponding layers of a solid, sorptive or swellable support (called sorptive support below), to which the sample is applied. Typically, the entire test stick does not consist of the sorptive support. Instead, the test stick preferably consists of a stable substrate, for example made of plastic, which is partly covered with a sorptive support. This part of the test stick which is covered by the sorptive support is also called a zone. After contact of the zone which comprises the corresponding determination reagents with the sample, the determination reaction proceeds. The colour formed is a measure of the amount of analyte to be determined and can be evaluated visually, i.e. semi-quantitatively, or quantitatively using simple reflectometers.

The sorptive supports used can be all materials which are usually used for such tests. The most widespread is the use of filter paper, but it is also possible to employ other sorptive cellulose or plastic products. The sorptive supports are impregnated in a known manner with impregnation solutions which comprise all reagents necessary for the determination. The impregnated and dried papers can be cut to size in a suitable manner and adhesively bonded or heat-sealed to the stable substrates, for example support films or foils, in a known manner. In exactly the same way, the sorptive support can firstly be adhesively bonded or heat-sealed to the stable substrate, for example support films or foils, in a known manner, and the impregnation solution can subsequently be applied dropwise to the sorptive support. The impregnated and dried products can then be cut to size in a suitable manner.

The determination system described here uses phloroglucine as chromophore or determination reagent and a strong base in order to produce the pH necessary for the determination reaction. In a preferred embodiment, the determination system also comprises at least one primary or secondary amine as inhibitor for setting the desired measurement range. The determination system is in the form of an impregnated matrix, i.e. all reagents necessary for the determination of the aldehydes are embedded in a sorptive support. The resultant colour reaction is evaluated, for example, reflectometrically or visually by comparison with a colour chart.

The test sticks according to the invention are typically produced by firstly impregnating a sorptive support with an impregnation solution. The impregnation solution comprises at least phloroglucine and a base. The impregnation solution is preferably an aqueous solution. Instead of water, however, the impregnation solution may also comprise one or more organic solvents or a mixture of water with one or more water-miscible organic solvents as solvent.

The concentration of phloroglucine in the impregnation solution is typically between 0.5 and 500 g of phloroglucine per litre of impregnation solution. The concentration is preferably between 10 and 80 g of phloroglucine per litre of impregnation solution.

The impregnation solution is preferably applied to the test strip in such a way that about 0.05 to 0.5 mg, preferably between 0.1 and 0.2 mg, of phloroglucine are located in a reaction zone (6×6 mm).

A suitable base in accordance with the invention is any base which is able to produce a pH of greater than or equal to pH 10, preferably greater than or equal to pH 13, in the impregnation solution. Bases which are suitable in accordance with the invention are organic bases or inorganic bases, such as KOH or NaOH. The impregnation solution particularly preferably comprises 1 to 5 mol/l of NaOH.

In addition, further substances, such as stabilisers or the like, may optionally be added to the impregnation solution.

It has been found that a quantitative determination in a desired concentration range can be achieved if an inhibitor is employed besides the chromophore phloroglucine. This inhibitor inhibits the formation of the colour signal.

It has been found that one or more primary or secondary amines can be employed as inhibitor for the determination according to the invention. Tris(hydroxymethyl)aminomethane is particularly preferably used.

The inhibitor can be added to the sample solution before the measurement or preferably added in a certain concentration to the impregnation solution during production of the test stick, so that it is possible to calculate from the known inhibitor concentration how much aldehyde does not participate in the aldehyde determination owing to the inhibitor by means of the colour reaction with phloroglucine. In this way, a measurement can be carried out in any desired aldehyde concentration range by addition of a suitable amount of inhibitor without needing to dilute the sample solution in advance. A colour signal which is proportional to the total aldehyde concentration is obtained in the desired concentration range. This is shown in Example 3.

In an embodiment, the test stick according to the invention has two or more zones instead of a determination or reaction zone. These zones differ in the amount of inhibitor. For example, one zone comprises no inhibitor, a second zone comprises 1% by weight of inhibitor (1% by weight based on the proportion in the impregnation solution), a third zone comprises 2% by weight of inhibitor. In this way, three measurements can be carried out in different aldehyde concentration ranges using one test stick. Test sticks having two or more zones are particularly suitable for aldehyde determinations in sample solutions whose aldehyde content is completely unknown.

The present invention also relates to a method for the determination of the aldehyde content of sample solutions, characterised by the following method steps
a) provision of a sample solution and a test stick according to the invention
b) brief dipping of the test stick into the sample
c) visual and/or spectroscopic, preferably reflectometric, evaluation of the coloration of the test stick

The test sticks according to the invention are typically dipped into the sample solution only very briefly, i.e. for one second or less. Wetting of the test stick once is sufficient. The evaluation can typically be carried out after only 20 to 120 seconds. In order to obtain comparable or reproducible measurement results, the evaluation of the test stick should always be carried out after a defined time, for example after 20, 60, 90 or 120 seconds. For the evaluation, the yellow/orange coloration occurring can be compared, for example, with a colour chart or evaluated reflectometrically, for example using a hand reflectometer (for example RQFlex®, Merck KGaA, Germany).

The measurement range of the means and method according to the invention without addition of inhibitor is typically between 0.2 and 4% by weight of aldehyde in the sample solution. The measurement range can vary slightly depending on the aldehyde, for example depending on the molecular weight and reactivity of the aldehyde. The addition of inhibitor generally enables the measurement range to be shifted to aldehyde concentrations which are 4 times higher.

It has thus been possible to provide a simple, rapid and reliable means and method for the determination of the content of aldehydes, which can also be carried out, for example, by cleaning personnel on site in order to check the disinfectants. The essential advantages of the dry-chemical method according to the invention, besides simple handling, also include straight-forward disposal owing to the small amounts of reagents.

Even without further comments, it is assumed that a person skilled in the art will be able to utilise the above description in the broadest scope. The preferred embodiments and examples should therefore merely be regarded as descriptive disclosure which is absolutely not limiting in any way.

The complete disclosure content of all applications, patents and publications mentioned above and below, in particular the corresponding application DE 102009019902, filed on May 5, 2009, is incorporated into this application by way of reference.

### EXAMPLES

### Example 1

### Determination of Acetaldehyde in Aqueous Solution by means of Visual Evaluation (Colour Comparison)

### Preparation of the Impregnation Solution:

10.0 g of phloroglucine is dissolved in 250 ml of 2 N aqueous sodium hydroxide solution.

### Production of the Test Sticks:

A strip of filter paper with a width of about 6 mm (for example Hollingsworth & Vose, “Binzer 1588”) is heat-sealed onto a white support film by means of hot-melt adhesive (for example Dynapol S 1272 adhesive). The abovementioned impregnation solution is applied dropwise to the paper zone of this strip in an amount of about 2 ml per metre of the filter paper with a width of 6 mm and immediately dried. This film is then cut transversely every 6 mm, resulting in a reaction zone comprising impregnated paper with the approximate dimensions 6 mm×6 mm.

### Analysis:

The test sticks produced in this way are dipped into the solution to be investigated for 1 sec, shaken off and assessed after precisely 60 sec. In the present example, the sticks are dipped into solutions of acetaldehyde (0 to 2.5% by weight) in water. Depending on the acetaldehyde concentration, an orange/yellow colour forms on the reaction zone, enabling semi-quantitative determination by comparison with a colour scale.

### Example 2

### Determination of Formaldehyde, Acetaldehyde, Glutaraldehyde and Glyoxal in Aqueous Solution by means of Quantitative Evaluation (Reflectometric)

Preparation of the Impregnation Solution and Production of the Test Sticks:

As in Example 1

### Analysis:

The test sticks are dipped into the solution to be investigated for 1 sec, shaken off and measured after precisely 60 sec at λ≈576 nm using an RQflex® reflectometer. FIG. 1 shows the reflectometric evaluation of the sticks after dipping into the sample solution for 1 sec and the colour development after dipping into the sample solution for 60 sec.

### Example 3

### Adjustment of the Sensitivity of the Glutaraldehyde determination using Tris(Hydroxymethyl)Aminomethane (Documented Reflectometrically)

### Preparation of the Impregnation Solution:

10.0 g of phloroglucine is dissolved in 250 ml of 2 N aqueous sodium hydroxide solution. Various amounts of tris(hydroxymethyl)aminomethane (CAS No. 77-86-1) are then added to this solution:
(a) no further addition: c(amine)≈0%
(b) 2.5 g per 280 g of the above-mentioned solution: c(amine)≈1%
(c) 5.0 g per 280 g of the above-mentioned solution: c(amine)≈2%
(d) 10.0 g per 280 g of the above-mentioned solution: c(amine)≈4%.

### Analysis:

The test sticks are dipped into the solution to be investigated for 1 sec, shaken off and measured after precisely 60 sec at λ≈576 nm using an RQflex® reflectometer.

FIG. 2 shows the reflectometric evaluation of the sticks after dipping into the sample solution for 1 sec and the colour development after dipping into the sample solution for 60 sec. The shift in the measurement range to higher concentrations is clearly evident.

1. Test stick which has at least one zone which comprises at least phloroglucine and a base.

2. Test stick according to claim 1, characterised in that the zone of the test stick additionally comprises at least one primary or secondary amine besides phloroglucine and a base.

3. Test stick according to claim 1, characterised in that the base is sodium hydroxide.

4. Test stick according to claim 1, characterised in that the primary or secondary amine is tris(hydroxymethyl)aminomethane.

5. Test stick according to claim 1, characterised in that the test stick has at least two zones which comprise phloroglucine and a base as well as various amounts of a primary or secondary amine.

6. Method for the determination of aldehydes, characterised by at least the following method steps:
a) provision of a test stick according to claim 1
b) dipping of the test stick into the sample solution
c) evaluation of the coloration of the test strip.

7. Method according to claim 6, characterised in that the evaluation in step c) is carried out reflectometrically.

8. A method comprising determining the aldehydes in aqueous solutions, such as, in particular, disinfectants, comprising using a test stick of claim 1.
